(19) United States
(12) Patent Application Publication
(10) Pub. No.: US 2008/0217921 A1
(43) Pub. Date: Sep. 11, 2008

(54) WAVE ENERGY HARNESSING DEVICE

(76) Inventor: MICHAEL WILLIAM RAFTERY, Hawley, PA (US)

Correspondence Address: GREENBERG TRAURIG, LLP, 200 PARK AVE., P.O. BOX 677, FLORHAM PARK, NJ, 07932, US

(21) Appl. No.: 12/042,845

(22) Filed: Mar. 5, 2008

Related U.S. Application Data
(60) Provisional application No. 60/906,148, filed on Mar. 9, 2007.

(51) Int. Cl. F03B 13/14

(52) U.S. Cl. 290/53

(57) ABSTRACT

A system for converting fluid surface wave energy into electrical energy. The system includes an electrical generating device, positioned in a waterproof housing, for producing electrical energy. A float, deployed on the fluid surface, is attached to the generating device when the housing is submerged within the fluid. Vertical motion of the surface waves produce vertical motion of the float, which turns and powers the electrical generating device. A plurality of anchors, positioned on the fluid floor, are attached to the housing so that the housing may be positioned proximate the fluid surface for creating a shoaling effect when a plurality of systems are deployed on the fluid surface.

### CROSS-REFERENCE TO RELATED APPLICATION

This application is a Section 111(a) application relating to commonly owned, co-pending U.S. Provisional Application Ser. No. 60/906,148 entitled “WAVE ENERGY HARVESTING DEVICE” filed Mar. 9, 2007.

### FIELD OF THE INVENTION

The present invention relates to mechanical energy harnessing devices. Technologies related to this invention fall within the more general fields of Ocean, Mechanical, and Electrical Engineering.

### BACKGROUND OF THE INVENTION

Systems for converting the mechanical energy of surface waves to electrical power are known to exist. However, the heavy mechanical equipment required to generate electricity is housed in buoys that operate within the dangerous, high-energy region of surface waves. Such arrangements are limited to operating in waves of roughly 15 feet. At greater wave heights, the systems must be put into a lock-down or “survival” mode.

Further, present systems are limited by the technologies used to transmit the mechanical energy to the power generation subsystems. Present technologies include oscillating devices that use air pressure to drive a turbine, a piston to drive a hydraulic system, or linear rare-earth magnets to generate oscillating electrical fields. Systems that rely on such technologies can only harness the energy over limited stroke lengths.

### SUMMARY OF THE INVENTION

The present invention comprises a system to convert surface wave energy in a body of water into electricity using a buoy-driven electrical generation subsystem, and to deliver the electricity to shore-based utilities. The heavy mechanical components of the electrical generation subsystem are contained in a water-tight housing anchored to the floor of the water body. A cable reel and flotation device enable the system to harness the largest waves recorded on the sea surface. By using winches and anchors, the electrical generation subsystem can be lowered to a safe depth during storms or can be raised near the surface for a shoaling effect in calm seas. The minimum depth of the anchors will be determined by the historic wave climate in the region of operation. This arrangement protects the components of the electrical generation subsystem from the effects of exceptionally large surface waves, such as those generated by large storms and hurricanes.

The present invention also has a greater range of operation relative to those of existing systems. All other existing systems are operationally limited by wave height. The novel system of the present invention may be designed to be fully operational in waves over 30 meters in height, resulting in an increased electrical output and storage capacity relative to other known existing systems.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a schematic view of an energy conversion system constructed in accordance with the present invention; and

FIG. 2 is a schematic diagram of an electrical generation sub-system of the energy conversion system shown in FIG. 1.

### DETAILED DESCRIPTION OF THE INVENTION

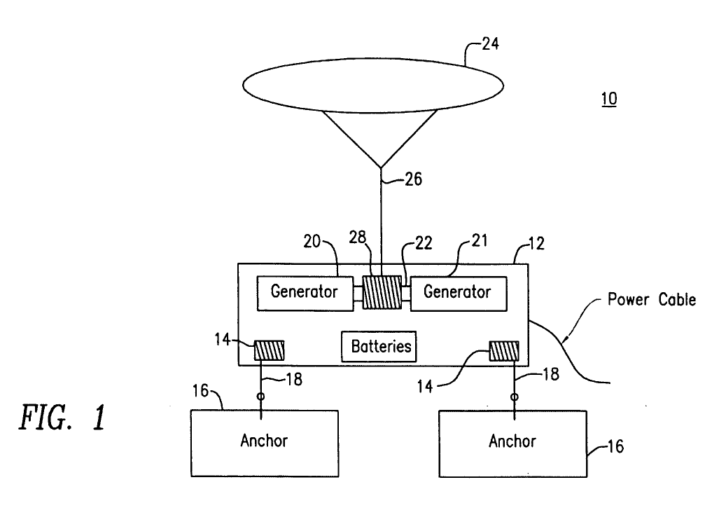

Turning to FIG. 1, in a preferred embodiment, the present invention 10 includes a water-tight housing 12 that can be lowered and raised by winches 14 connected to anchors 16 by cables 18. The anchors 16 are set in the floor of a body of water such as the ocean. Preferably, the water-tight housing 12 is cylindrical in shape and is anchored at four points. An electrical generation system 20, 21 is contained in the water-tight housing 12 through fittings for power and control cables. The electrical generation system 20, 21 is powered by a shaft 22 fixed or coupled to a cable reel 28, and is connected to power cables to return electrical power to a substation. The shaft 22 may be installed in the housing 12 in the same manner by which a propeller shaft is installed in a boat or submarine. In a typical embodiment, there would be redundant generation systems 20, 21 connected by the shaft 22. The cable reel 28 is tethered to a flotation device 24 on the surface of the water by cable 26.

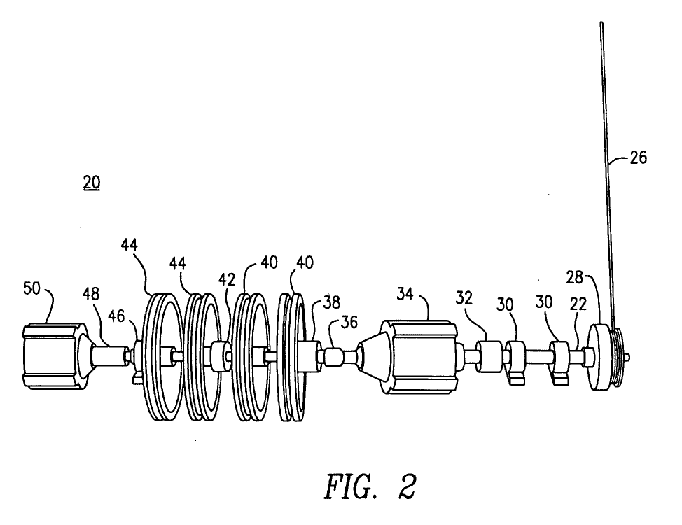

Turning to FIG. 2, in a preferred embodiment, the electrical generation system 20 comprises, from right to left, a spring rewind cable reel 28 with shaft 22 fixed to the side of the reel 28, two pillow blocks 30 supporting the shaft 22, a one-way clutch bearing 32, a gearbox 34, a second one-way clutch bearing 36, pillow block 38, a pair of flywheels 40, a third pillow block 42, a second pair of flywheels 44, a fourth pillow block 46, a helical coupler 48 to correct any misalignment, and an alternator 50. The one-way clutch bearing 32 is arranged so that the shaft turns the gears (not shown) within the gearbox 34 in only one direction, and the one-way clutch bearing 36 is arranged so that the flywheels 40, 44 do not turn the gears within the gearbox 34. In the preferred embodiment shown in FIG. 1, the shaft 22 would be extended away from the opposite end of the cable reel 28, and the second electrical generation system 21 arranged on the staff extension. Other arrangements of components in the electrical generation systems may be apparent to those experienced in the electromechanical arts.

In operation, a wave passing over the housing 12 will lift the flotation device 24, which in turn lifts the cable 26 on the reel 28, thus turning the reel 28 and the shaft 22. The turning shaft 22 simultaneously turns gears in the gearbox 34 to power the electrical alternator 50 and also charges a rewind system (not shown), such as a hydraulic accumulator, spring, or spring and gear, which is connected operationally to the reel 28. The input to the gears is mechanically rectified by the clutch bearing 32 so that the gears turn in only one direction. The output from the gears is input to the flywheels, 40, 44, which are connected to the alternator 50 to produce electricity. Once the flotation device 24 passes over the crest of the wave, the rewind system reverses the rotation of the cable reel 26, and the cycle repeats with the next wave.

In concept, a number of similar systems, up to about a hundred, may be connected by their power cables to a sea floor substation that conditions the collective electrical inputs and transfers the cumulative input onto a larger capacity sea floor cable that is run to shore. Further, electrical power from a group of substations may be collected so that thousands of units may operate in off shore wave farms to replace existing power plants.

The present invention overcomes the limitations of the prior art by harvesting energy from much larger waves. Through appropriate designs, the housing 12 may be made sufficiently water-tight to protect the electrical generation systems 20, 21 at depths great enough to allow the systems 20, 21 to operate in the presence of extremely large surface waves without requiring a “survival mode”. Further, the anchors 16 and winches 14 can be used to adjust the depth of the housing 12 in the water column to optimize the ability of the invention to harness wave power by utilizing the shoaling effect. The shoaling effect on waves is controlled by raising or lowering the housing 12 based on signals from sensors attached thereto (not shown) or signals from a remote source. The signals are processed in a control system (not shown) to raise or lower the housing 12 in order to vary the shoaling effect. At the contemplated depths, it is inevitable that some water will leak into the housing 12 through cracks and seals, but no more would be expected than could readily be removed with devices such as bilge pumps powered by rechargeable batteries. All of the components of the present invention are readily available.

It should be understood that the embodiment discussed herein is merely exemplary and that a person skilled in the relevant arts may make many variations and modifications without departing from the spirit and scope of the invention. All such variations and modifications, including those discussed above, are intended to be included within the scope of the invention as defined in the appended claims.

We claim:

1. A system for converting wave energy of a fluid into electrical energy, comprising:
a housing;
generating means, positioned within said housing, for generating electrical energy;
floating means attached movably to said generating means and positioned proximate to a surface of the fluid, whereby vertical motion of surface waves of the fluid produces movement of said floating means, the movement of said floating means powering said generating means, said floating means creating a shoaling effect on the surface waves that pass over said floating means; and
anchoring means, attached to said housing, for anchoring said housing within the fluid.
